(19) United States
(12) Patent Application Publication
(10) Pub. No.: US 2023/0250576 A1
(43) Pub. Date: Aug. 10, 2023

(54) METHOD FOR ELECTROCHEMICAL GRAPHITIZATION OF CARBON FIBER

(71) Applicant: UT-Battelle, LLC, Oak Ridge, TN (US)

(72) Inventors: Sheng Dai, Knoxville, TN (US); Prashant Bagri, Hillsboro, OR (US); Huimin Luo, Knoxville, TN (US)

(21) Appl. No.: 18/107,715

(22) Filed: Feb. 9, 2023

Related U.S. Application Data
(60) Provisional application No. 63/308,651, filed on Feb. 10, 2022.

(51) Int. Cl. D06M 10/06

(52) U.S. Cl. CPC D06M 10/06; D06M 2101/40

(57) ABSTRACT

A method for converting amorphous carbon fiber to graphitized carbon fiber, the method comprising immersing the amorphous carbon fiber into a molten anhydrous alkaline earth salt (e.g., CaCl₂) and/or MgCl₂) maintained at a temperature within a range of 720° C.-920° C. or 780° C.-920° C. while the amorphous carbon fiber is cathodically polarized at a voltage within a range of −2.2V to −2.8V for a period of time (e.g., 0.5-6 hours) to result in conversion of the amorphous carbon fiber to the graphitized carbon fiber, wherein the graphitized carbon fiber is at least partially graphitized.

### CROSS REFERENCE TO RELATED APPLICATION

The present application claims benefit of U.S. Provisional Application No. 63/308,651, filed on Feb. 10, 2022, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to methods for converting carbon fiber to graphitized carbon fiber. The present invention more particularly relates to electrochemical methods for converting carbon fiber to graphitized carbon fiber.

### BACKGROUND

Carbon fibers have several desirable properties, such as high tensile strength, low weight, high chemical resistance, high temperature tolerance, and low thermal expansion. Because of these attractive properties, carbon fibers have been used to replace steel in heavy duty products, such as aircraft, military equipment, and high speed vehicles. Carbon fiber composites have higher strength-to-weight ratios than the materials previously used in aircraft, making aircraft lighter, and thus, more fuel efficient. The fuselage, wings, and other components of some jet airliners contain significant quantities of carbon-fiber-reinforced polymer (CFRP) composites.

Carbon fiber needs to be graphitized to increase its tensile strength and modulus to make it suitable for use in heavy duty equipment. Currently, the graphitization of carbon fibers requires multiple steps involving heating the sample to a series of temperatures: stabilization (200-300° C.), carbonization (1,000-1,700° C.), and graphitization (2,500-3000° C.). This results in a significant rise in the cost of the carbon fiber, which in turn impedes its widespread use in common automobiles. Efforts to simplify the graphitization process and lower its cost have been largely unsuccessful. Thus, there would be a significant advantage in a process that could provide a more straight-forward and lower cost process for the graphitization of carbon fiber.

### SUMMARY

The present disclosure describes a method for converting carbon fiber (in its amorphous form) to a graphitized form by a straight-forward electrochemical approach that precludes the use of molten metals and the safety hazards associated with them. The technology described herein provides a graphitization process involving the cathodic polarization of carbon fiber in a molten salt. The process results in graphitic carbon fiber in a relatively shorter time scale than conventional methods. The currently described process is simpler than existing processes and operates at substantially lower temperatures. The method may more particularly involve the electrochemical transformation of carbon fiber by immersing the fiber in molten anhydrous alkaline earth salt (e.g., CaCl₂ or MgCl₂) at substantially lower temperatures (e.g., 720° C.-920° C.) than conventional processes and over generally shorter time periods.

More particularly, the method includes: immersing the carbon fiber into molten anhydrous alkaline earth salt maintained within a temperature range of 720° C.-920° C. while the carbon fiber is cathodically polarized at a voltage within a range of −2.2V to −2.8V for a sufficient period of time (e.g., 1-6 hours) to result in conversion of the carbon fiber to graphitized carbon fiber. The present disclosure is also directed to the resulting graphitized carbon fiber produced by the foregoing method, wherein the resulting graphitized carbon fiber may possess unique physical features distinct from graphitized carbon fiber produced by conventional means, e.g., a missing crystalline peak at 44° in the x-ray diffraction (XRD) spectrum and partial retention of properties associated with hard carbon.

### BRIEF DESCRIPTION OF THE DRAWINGS

FIG. 1. Schematic representation of a graphitization reactor set-up and electrochemical approach for the graphitization of carbon fiber.

FIG. 2. Raman spectra of as-received carbon fiber (bottom) and electrochemically graphitized carbon fiber (top).

FIG. 3. Scanning electron microscope (SEM) images of carbon fiber before graphitization (image a) and post graphitization (image b).

### DETAILED DESCRIPTION

The present disclosure is foremost directed to a method for converting carbon fiber (i.e., starting carbon fiber) to graphitic carbon fiber. The starting carbon fiber is composed of amorphous carbon rather than graphitic (crystalline) carbon. For this reason, the starting carbon fiber is herein referred to as “amorphous carbon fiber”. The amorphous carbon fiber may be hard (non-graphitizable) or soft (graphitizable). In some embodiments, the amorphous carbon fiber is composed of hard amorphous carbon resistant to graphitization. The amorphous carbon fiber may be derived from any carbon fiber precursor, including polyacrylonitrile (PAN) or lignin, in which case the starting carbon fiber may be referred to as PAN-derived or lignin-derived amorphous carbon fiber. The carbon fiber being processed typically has a length of at least 1 cm or 1 meter and a width of up to or less than 100, 50, or 25 microns. In some embodiments, the carbon fiber is discontinuous by having a length of no more than 1 meter or 10 cm. In other embodiments, the carbon fiber is continuous by having a length of at least or more than 1, 2, 3, 4, 5, 10, 20, or 30 meters, in which case the carbon fiber is typically held (i.e., wound) on a spool from which the carbon fiber can be unwound at a desired speed for processing.

In the method, the carbon fiber is immersed in molten anhydrous alkaline earth salt maintained within a temperature range of 720° C.-920° C. while the carbon fiber is cathodically polarized at a voltage within a range of −2.2V to −2.8V for a sufficient period of time of to result in conversion of the amorphous carbon fiber to the graphitic carbon fiber. The term “immersed,” as used herein, indicates that the amorphous carbon fiber or desired portion thereof is completely submerged in and in contact with the molten anhydrous alkaline earth salt. The phrase “sufficient period of time” is typically at least 2 minutes, and may be, 5, 10, 20, or 30 minutes or 1, 2, 3, 4, 5, or 6 hours, or a period of time within a range therein (e.g., 0.5-6 hours or 1-6 hours). The term “graphitized carbon fiber,” as used herein, includes carbon fiber that has been partially or completely graphitized. Notably, the period of time the carbon fiber is immersed in the molten alkaline earth salt can be varied depending on whether a partially or completely graphitized carbon fiber is desired.

The phrase “maintained within a temperature range” may, in a first embodiment, mean maintaining the molten anhydrous alkaline earth salt at a particular (i.e., single) temperature within the specified temperature range during the period of time the amorphous carbon fiber is cathodically polarized and immersed in the molten anhydrous alkaline earth salt. In a second embodiment, the phrase “maintained within a temperature range” permits a change or fluctuation in temperature to occur in the molten anhydrous alkaline earth salt, provided that the temperature of the molten anhydrous alkaline earth salt remains within the specified temperature range. The change or fluctuation in temperature may be, for example, ±1, 2, 5, or 10° C. from a given selected temperature in the range, provided the varying temperatures remain within the range. The molten anhydrous alkaline earth salt can be heated by any suitable means known in the art, e.g., by being placed in an electric furnace or by being wrapped in heating tape, while contained in a suitable crucible or other vessel.

The molten anhydrous alkaline earth salt (i.e., molten salt) can contain a single alkaline earth salt or a mixture of alkaline earth salts that can be molten within a temperature range of 720° C.-920° C. or more particularly 780° C.-920° C. or 780° C.-850° C. In some embodiments, the alkaline earth salt includes or is solely composed of one or more alkaline earth halide salts, which may be, more particularly, one or more alkaline earth chloride salts, alkaline earth bromide salts, or alkaline earth iodide salts. In other embodiments, the alkaline earth salt includes or is solely composed of one or more alkaline earth nitrate salts, alkaline earth sulfate salts, or alkaline earth carbonate salts. Any eutectic mixture of any two of the above types of alkaline earth salts are also considered herein (e.g., a mixture of alkaline earth halide and nitrate salts). Notably, the alkaline earth salt should not be reactive with the carbon fiber. Any alkaline earth salt or other component present in the molten salt that can be reactive with carbon should be excluded from the molten salt.

In some embodiments, the molten anhydrous alkaline earth salt is CaCl₂ in the substantial absence of any other alkaline earth salt. In other embodiments, the molten anhydrous alkaline earth salt includes or is solely composed of calcium chloride (CaCl₂). In other embodiments, the molten anhydrous alkaline earth salt includes or is solely composed of magnesium chloride (MgCl₂). In other embodiments, the molten anhydrous alkaline earth salt includes or is solely composed of a eutectic mixture of CaCl₂ and MgCl₂. In the eutectic mixture, either of CaCl₂ or MgCl₂ may be in a larger or lesser amount by weight or molar amount, or the two salts may be present in equal weight or equal molar amount. In some embodiments, the anhydrous alkaline earth salt includes a eutectic mixture of CaCl₂ and MgCl₂, wherein the CaCl₂ is present in an amount greater than 50 wt % by weight (or 50 mol % by moles) of CaCl₂ and MgCl₂. In the eutectic, the CaCl₂ may be present in an amount of, for example, at least or greater than 55, 60, 65, 70, 75, 80, 85, 90, or 95 wt % by weight of CaCl₂ and MgCl₂, or an amount of CaCl₂ within a range bounded by any two of the foregoing values (e.g., 60-95 wt %), wherein any of the foregoing wt % values may alternatively be mol %.

In some embodiments, the molten anhydrous alkaline earth salt includes CaCl₂ and/or MgCl₂, such as described above, and at least one other salt, which may be a halide salt or nitrate salt. The one or more other halide or nitrate salts may be admixed with the molten CaCl₂ and/or MgCl₂, provided that the one or more other halide or nitrate salts form a eutectic with the CaCl₂ and/or MgCl₂, with the eutectic generally having a lower melting point than the CaCl₂ and/or MgCl₂ alone, and with the CaCl₂ and/or MgCl₂ present in an amount of at least or more than 50, 60, 70, 80, 90, 95, 98, or 99 wt % of the eutectic (i.e., the one or more other metal salts present in an amount of up to or less than 50, 40, 30, 20, 10, 5, 2, or 1 wt %). Some examples of one or more other salts that may be included in molten CaCl₂ and/or MgCl₂ salt include lithium chloride, lithium nitrate, gallium chloride, indium chloride, zinc chloride, and zinc nitrate. In some embodiments, any one or more other salts described above (or any other salts altogether) may be excluded from the molten CaCl₂ and/or MgCl₂. In other embodiments, one or more metal halides or other metal salts having a melting point above CaCl₂ and/or MgCl₂ (e.g., SrCl₂) may be present in an amount of no more than or less than 10, 5, 2, or 1 wt % of the molten CaCl₂ and/or MgCl₂, or such other metal salts may be excluded (i.e., 0 wt %).

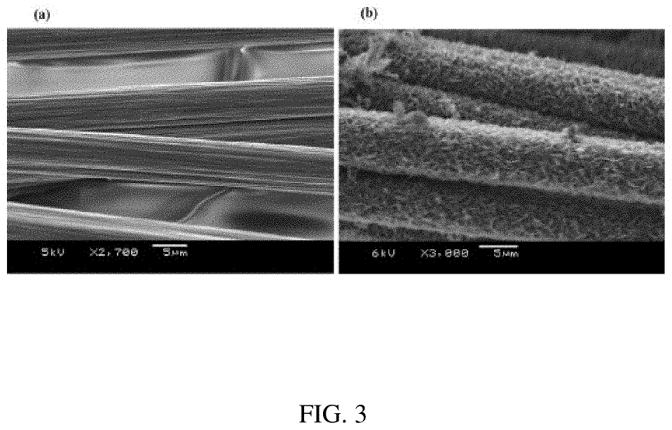

In some embodiments, one or more advantages may be provided by using CaCl₂ without MgCl₂ or other salt in the molten salt for the graphitization of carbon fiber. First, it has herein been observed that graphitization in CaCl₂ is slower than in MgCl₂, and this offers more reaction control. This is particularly important for carbon fiber since it has a very large aspect ratio. A very high reaction rate, which may occur using MgCl₂, results in less control of the degree of graphitization, which may cause the fiber to become more brittle and lose some of its high-strength properties. Moreover, molten CaCl₂ is less aggressive in the removal of oxygen from the amorphous carbon. As the removal of oxygen induces graphitization in carbonaceous materials, the milder reaction conditions afforded by CaCl₂ help maintain a much more controlled transformation of carbon to graphitic graphitization. Notably, this more controlled transformation results in formation of individual graphitic flakes on the fiber while maintaining the fiber structure, as shown in FIG. 3 (image b).

In different embodiments, the temperature of the molten anhydrous alkaline earth salt is maintained at a temperature of, for example, 720° C., 730° C., 740° C., 750° C., 760° C., 770° C., 780° C., 790° C., 800° C., 810° C., 820° C., 830° C., 840° C., 850° C., 860° C., 870° C., 880° C., 890° C., 900° C., 910° C., or 920° C., or a temperature within a range bounded by any two of the foregoing temperatures (e.g., 720° C.-920° C., 750° C.-920° C., 780° C.-920° C., 820° C.-920° C., 850° C.-920° C., 880° C.-920° C., 720° C.-850° C., 750° C.-850° C., 780° C.-850° C., 820° C.-850° C., 720° C.-820° C., 750° C.-820° C., 780° C.-820° C., 720° C.-800° C., 750° C.-800° C., or 780° C.-800° C.). In different embodiments, the cathodic voltage is −2.2V, −2.3V, −2.4V, −2.5V, −2.6V, −2.7V, or −2.8V, or a cathodic voltage within a range bounded by any two of the foregoing values (e.g., −2.2 to −2.8V, −2.4 V to −2.8 V, or −2.3 to −2.7V). In different embodiments, the period of time that the amorphous carbon fiber is immersed in the molten anhydrous alkaline earth salt while cathodically polarized is at least or precisely, for example, 2 minutes, 5 minutes, 10 minutes, 20 minutes, 30 minutes, 60 minutes (1 hour), 90 minutes, 2 hours, 3 hours, 4 hours, 5 hours, 6 hours, 12 hours, 15 hours, 18 hours, or 24 hours, or a period of time within a range bounded by any two of the foregoing values.

The amorphous carbon fiber, while immersed in the molten anhydrous alkaline earth salt, needs to be in direct or indirect contact with a working cathode in order for the amorphous carbon fiber to be cathodically polarized. The carbon fiber can be in contact directly with the cathode itself or may be in contact with one or more conductive wires or plates in contact with the cathode. In particular embodiments, the carbon fiber is wrapped within and in contact with a conductive metal (metallic) mesh serving as the cathodic working electrode (i.e., itself the cathode or in contact with the cathode). Notably, the metal mesh or other cathodic material should not be reactive with the molten anhydrous alkaline earth salt or any eutectic component (if present). The metal mesh or other cathodic material should also not be reactive with carbon. The metal mesh may be constructed of or include, for example, molybdenum, nickel, copper, zinc, titanium, cobalt, palladium, platinum, or gold. In the process, the cathode is also necessarily in electrical communication with a counter electrode (anode), which may be, for example, glassy carbon rod.

In another aspect, the present disclosure is directed to the resulting graphitized carbon fiber produced by the foregoing methods. In some embodiments, the resulting graphitized carbon fiber has been unexpectedly found to possess unique physical features distinct from their conventionally produced counterparts, e.g., absence of sharp crystalline peak at about 44° (i.e., 2θ of 44°) in the x-ray diffraction (XRD) spectrum and partial retention of properties associated with hard carbon. The foregoing peak generally represents the presence of a three-dimensional crystallographic coherency in the graphite. This absence of the peak suggests that the graphite may retain some properties of amorphous carbon. The graphitized carbon fiber produced by the above-described method may also exhibits a sharp crystalline peak at about 26° (i.e., 2θ of 26°) in the x-ray diffraction (XRD) spectrum. Moreover, in some embodiments, the graphitized carbon fiber has a nanoflake architecture on its surface.

In some embodiments, the amorphous carbon fiber is a continuous carbon fiber (e.g., of at least 1, 2, 5, 10, 20, or 50 meters in length), and the continuous carbon fiber is fed into and passed through the molten anhydrous alkaline earth salt in a continuous graphitization process. The continuous carbon fiber is typically held on a spool and unwound from the spool as it is fed into and passed through the molten anhydrous alkaline earth salt in the continuous graphitization process. The speed at which the continuous carbon fiber is dispensed (or equivalently, the speed at which the spool is rotated to unwind the fiber) and fed into the molten anhydrous alkaline earth salt can be suitably adjusted to correspondingly adjust the residency time of the carbon fiber in the molten anhydrous alkaline earth salt.

In another aspect, the present disclosure is directed to a lithium-ion battery (LIB) containing graphitized carbon fiber, as produced above, in at least the anode (negative charge on discharge) or cathode (positive charge on discharge) of the lithium-ion battery. Typically, when present in the LIB, the graphitized carbon fiber is in chopped form, e.g., no more than or less than 1 mm in length. Lithium-ion batteries are well known in the art. The lithium-ion battery may contain any of the components typically found in a lithium ion battery, including positive and negative electrodes (i.e., cathode and anode, respectively), current collecting plates, and a battery shell, such as described in, for example, U.S. Pat. Nos. 8,252,438, 7,205,073, and 7,425,388, the contents of which are incorporated herein by reference in their entirety.

The negative electrode (anode) of the lithium-ion battery may be constructed of any of the suitable compositions well known in the art. In some embodiments, the negative electrode is or includes the graphitized carbon fiber produced as described above. In other embodiments, the negative electrode contains a conventional anodic material either in place of or in combination (e.g., in admixture) with the graphitized carbon fiber. The negative electrode may include any of the carbon-containing and/or silicon-containing anode materials well known in the art of lithium-ion batteries. The carbon-containing composition is typically one in which lithium ions can intercalate or embed, such as graphite (e.g., natural or artificial graphite), petroleum coke, carbon fiber (e.g., mesocarbon fibers), carbon (e.g., mesocarbon) microbeads, fullerenes (e.g., carbon nanotubes, i.e., CNTs), and graphene. The silicon-containing composition, which may be used in the absence or presence of a carbon-containing composition in the anode, can be any of the silicon-containing compositions known in the art for use in lithium-ion batteries. Lithium-ion batteries containing a silicon-containing anode may alternatively be referred to as lithium-silicon batteries. The silicon-containing composition may be, for example, in the form of a silicon-carbon (e.g., silicon-graphite, silicon-carbon black, silicon-CNT, or silicon-graphene) composite, silicon microparticles, or silicon nanoparticles, including silicon nanowires. The negative electrode may also be a metal oxide, such as tin dioxide (SnO₂) or titanium dioxide (TiO₂), or a composite of carbon and a metal oxide. The lithium-ion battery may also be a lithium-sulfur battery, wherein sulfur and/or lithium sulfides may be admixed at the cathode with the graphitized carbon fiber described above.

The positive electrode (cathode) of the lithium-ion battery may be constructed of any the suitable compositions well known in the art. In some embodiments, the positive electrode is or includes the graphitized carbon fiber produced as described above. In some embodiments, the cathode includes a conventional cathode material admixed with the graphitized carbon fiber. The conventional cathode material can be, for example, manganese dioxide (MnO₂), iron disulfide (FeS₂), copper oxide (CuO), or a lithium metal oxide, wherein the metal is typically a transition metal, such as Co, Fe, Ni, or Mn, or combination thereof. Some examples of lithium metal oxides include LiCoO₂, LiNiCoO₂, LiMnO₂, and LiFePO₄. In an effort to increase the energy density of the LIBs, 5.0V positive electrode materials, such as LiNi_{0.5}Mn_{1.5}O₄, LiNiₓCo₁₋ₓPO₄, and LiCuₓMn₂₋ₓO₄, have also been developed (Cresce, A. V., et al., Journal of the Electrochemical Society, 2011, 158, A337-A342). In some embodiments, the cathode material contains at least lithium, nickel, manganese, cobalt, and oxide. Such compositions are typically referred to as NMC compositions. The composition typically has the formula LiNiₓMn_{y}Co_{z}O₂, wherein x+y+z=1, and each of x, y, z>0. In some embodiments, x, y, and z are each in a range of 0.2-0.5, or x may be precisely or at least 0.5, 0.55, 0.6, 0.65, 0.7, 0.75, or 0.8 or within a range bounded by any two of these values. Some examples of NMC compositions include LiNi_{1/3}Mn_{1/3}Co_{1/3}O₂ (i.e., LiNiMnCoO₂ or NMC111), LiNi_{0.5}Mn_{0.3}Co_{0.2}O₂ (NMC532), LiNi_{0.8}Mn_{0.1}Co_{0.1}O₂ (NMC811), and LiNi_{0.6}Mn_{0.2}Co_{0.2}O₂ (NMC622). The cathode may alternatively have a layered-spinel integrated Li[Ni_{1/3}Mn_{2/3}]O₂ composition, as described in, for example, Nayak et al., Chem. Mater., 2015, 27 (7), pp. 2600-2611. To improve conductivity at the positive electrode, conductive carbon material (e.g., carbon black, carbon fiber, or graphite) is often admixed with the positive electrode material. In some embodiments, any one or more classes or specific types of conventional cathode materials are excluded from the cathode.

In the lithium-ion battery, the positive and negative electrode compositions are often admixed with an adhesive (e.g., PVDF, PTFE, and co-polymers thereof) in order to gain the proper viscosity and density for molding as electrodes. A conductive substance (e.g., a conductive carbon) may or may not also be included. Typically, positive and negative current collecting substrates (e.g., Cu or Al foil) are also included. The assembly of lithium-ion batteries is well known in the art.

The lithium-ion battery may also include a solid porous membrane positioned between the negative and positive electrodes. The solid porous membrane can be composed of, for example, a plastic or polymeric material (e.g., polyethylene, polypropylene, or copolymer thereof), or an inorganic material, such as a transition metal oxide (e.g., titania, zirconia, yttria, hafnia, or niobia) or main group metal oxide, such as silicon oxide, which can be in the form of glass fiber.

As well known in the art, the lithium-ion battery typically also includes a lithium-containing electrolyte, which contains a lithium salt. The lithium salt can, in one embodiment, be non-carbon-containing (i.e., inorganic) by having an inorganic counteranion. The inorganic counteranion can be, for example, a halide (e.g., chloride, bromide, or iodide), hexachlorophosphate (PCl₆⁻), hexafluorophosphate (PF₆⁻), perchlorate, chlorate, chlorite, perbromate, bromate, bromite, periodate, iodate, aluminum fluorides (e.g., AlF₄⁻), aluminum chlorides (e.g., Al₂Cl₇⁻ and AlCl₄⁻), aluminum bromides (e.g., AlBr₄⁻), nitrate, nitrite, sulfate, sulfite, phosphate, phosphite, arsenate, hexafluoroarsenate (AsF₆⁻), antimonate, hexafluoroantimonate (SbF₆⁻), selenate, tellurate, tungstate, molybdate, chromate, silicate, the borates (e.g., borate, diborate, triborate, tetraborate), tetrafluoroborate, anionic borane clusters (e.g., B₁₀H₁₀²⁻ and B₁₂H₁₂²⁻), perrhenate, permanganate, ruthenate, perruthenate, and the polyoxometalates. The lithium salt can, in another embodiment, be carbon-containing (i.e., organic) by including an organic counteranion. The organic counteranion may, in one embodiment, lack fluorine atoms. The organic counteranion can be, for example, carbonate, the carboxylates (e.g., formate, acetate, propionate, butyrate, valerate, lactate, pyruvate, oxalate, malonate, glutarate, adipate, decanoate, and the like), the sulfonates (e.g., CH₃SO₃⁻, CH₃CH₂SO₃⁻, CH₃(CH₂)₂SO₃⁻, benzenesulfonate, toluenesulfonate, dodecylbenzenesulfonate, and the like), the alkoxides (e.g., methoxide, ethoxide, isopropoxide, and phenoxide), the amides (e.g., dimethylamide or diisopropylamide), diketonates (e.g., acetylacetonate), the organoborates (e.g., BR₁R₂R₃R₄⁻, wherein R₁, R₂, R₃, R₄ are typically hydrocarbon groups containing 1 to 6 carbon atoms), anionic carborane clusters, alkylsulfates (e.g., diethylsulfate), alkylphosphates (e.g., ethylphosphate or diethylphosphate), dicyanamide (i.e., N(CN)₂⁻), tricyanamide (i.e., N(CN)₃⁻), and the phosphinates (e.g., bis-(2,4,4-trimethylpentyl)phosphinate). The organic counteranion may, in another embodiment, include fluorine atoms. For example, the lithium-containing species can be a lithium ion salt of such counteranions as the fluorosulfonates (e.g., CF₃SO₃⁻, CF₃CF₂SO₃⁻, CF₃(CF₂)₂SO₃⁻, CHF₂CF₂SO₃⁻, and the like), the fluoroalkoxides (e.g., CF₃O⁻, CF₃CH₂O⁻, CF₃CF₂O⁻, and pentafluorophenolate), the fluorocarboxylates (e.g., trifluoroacetate and pentafluoropropionate), and the fluorosulfonylimides (e.g., (CF₃SO₂)₂N⁻). In some embodiments, any one or more classes or specific types of lithium salts are excluded from the electrolyte. In other embodiments, a combination of two or more lithium salts is included in the electrolyte.

Examples have been set forth below for the purpose of illustration and to describe certain specific embodiments of the invention. However, the scope of this invention is not to be in any way limited by the examples set forth herein.

### Examples

Overview

A low temperature graphitization process in molten salts has been developed to graphitize low-cost, low-heat-treated carbon fiber into strong high modulus graphite fiber. The graphitization of low-quality carbon fiber was achieved at a suitable temperature (such as ˜800° C. to ˜900° C.), in a molten salt (such as CaCl₂, MgCl₂, or eutectic salt), at a suitable polarization potential (such as −2.6 V polarization potential) for approximately 2-4 hours. The graphitized carbon fiber was characterized by Raman spectroscopy and scanning electron microscopy (SEM), which confirmed the successful graphitization of the carbon fiber. Graphitized carbon fibers are attractive not only for fabricating high performing less expensive aircrafts, military equipment, automobiles, and sports cars, but also an excellent anode material for high energy/power density lithium-ion batteries (LIBS) because of their light weight. Graphitization of carbon fiber in molten salts, as described herein, lowers the cost of the process, which helps advance graphitized carbon fiber into the commercial market.

Conversion of Amorphous Carbon Fiber to Graphite Fiber

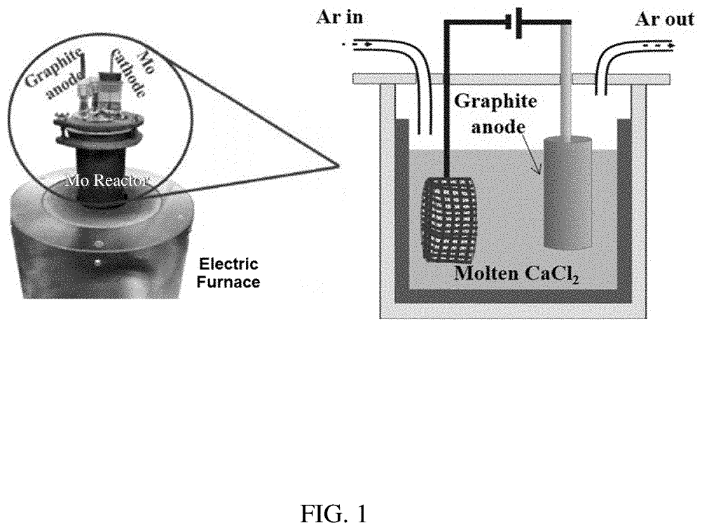

A general schematic of the process used for the electrochemical graphitization of carbon fiber is shown in FIG. 1. In the process, calcium chloride (CaCl₂) was used to graphitize PAN-derived carbon fiber. Cathodic polarization of −2.6 V was applied to the carbon fiber with CaCl₂ maintained at ˜800° C. to graphitize the carbon fiber to the desired degree of graphitization. The salts were dehydrated carefully to remove any moisture before the graphitization process. The starting (amorphous) carbon fiber was used as cathode (which is wrapped in nickel mesh and attached to a molybdenum rod) and coupled with a glassy carbon anode during the cathodic polarization. As further discussed below, the process was surprisingly successful in the graphitization of the carbon fiber at such a lower temperature and with high efficiency.

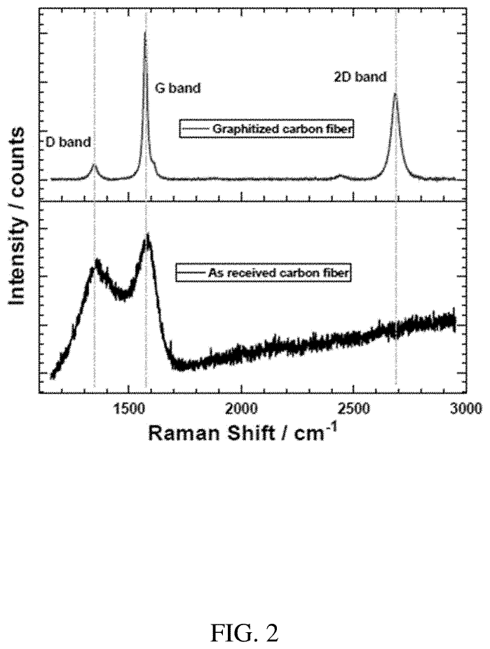

The graphitized carbon fibers were characterized by Raman spectroscopy (FIG. 2), and SEM analysis (FIG. 3 (a, b)). Notably, the Raman spectrum of the carbon sample has a distinct spectral feature (D, G, and 2D band) which clearly differentiate the amorphous and graphitized structure. Analysis of the Raman spectrum shows that the ID/IG ratio is 0.16 for graphitized carbon fiber, which is much smaller compared to the as-received carbon fiber (ID/IG=1.25), which indicates the successful graphitization. The sharp increase of the G band intensity and decrease in defect-induced D band and appearance of the 2D band, which is absent for the as-received carbon fiber, suggests a highly ordered graphitic structure after electrochemical graphitization. This is further verified by the nanoflake architecture seen at the surface of the graphitized carbon fiber. Such architecture is absent in the as-received carbon fiber (see FIG. 3 (a & b)). This demonstrates that the present technology successfully graphitized carbon fiber at a much lower temperature of about 800° C. using a molten salt system.

As provided above, the technology described herein successfully graphitized carbon fiber employing electrochemical graphitization technology in molten salts at much lower temperature (˜800° C.) than the conventional thermal graphitization method. The key features of the process include lower temperature, lower cost, much shorter synthesis time, and tunability of the process, all of which can be used to tailor the properties of the graphitized carbon fiber. The characterization of the graphitized carbon fiber shows the formation of a graphitic nanoflake architecture while still maintaining the fiber morphology. The resulting graphitized fiber is light weight and has a high tensile strength, modulus, and high stiffness, along with lower cost compared to the high-temperature treated carbon fiber. Thus, the graphitized carbon fiber produced by the present method can be more easily integrated into a variety of applications, including the fabrication of automobiles, at much lower prices. Moreover, because of its light weight, high stiffness, and graphitic structure, graphite fiber can provide high energy/power density lithium ion batteries (LIBs), and this will help advance electric vehicles for mainstream use.

While there have been shown and described what are at present considered the preferred embodiments of the invention, those skilled in the art may make various changes and modifications which remain within the scope of the invention defined by the appended claims.

What is claimed is:

1. A method for converting amorphous carbon fiber to graphitized carbon fiber, the method comprising immersing the amorphous carbon fiber into a molten anhydrous alkaline earth salt maintained at a temperature within a range of 720° C.-920° C. while the amorphous carbon fiber is cathodically polarized at a voltage within a range of −2.2V to −2.8V for a period of time to result in conversion of the amorphous carbon fiber to the graphitized carbon fiber, wherein the graphitized carbon fiber is at least partially graphitized.

2. The method of claim 1, wherein the amorphous carbon fiber is composed of hard amorphous carbon resistant to graphitization.

3. The method of claim 1, wherein the alkaline earth salt is an alkaline earth chloride salt.

4. The method of claim 3, wherein the alkaline earth chloride salt is CaCl₂ or MgCl₂ or a eutectic thereof.

5. The method of claim 3, wherein the alkaline earth chloride salt is CaCl₂ in the substantial absence of any other alkaline earth salt.

6. The method of claim 1, wherein the molten anhydrous alkaline earth salt is maintained at a temperature within a range of 780° C.-850° C.

7. The method of claim 1, wherein the molten anhydrous alkaline earth salt is maintained at a temperature within a range of 780° C.-820° C.

8. The method of claim 1, wherein the amorphous carbon fiber is cathodically polarized at said voltage for a period of time of 1-4 hours.

9. The method of claim 1, wherein the amorphous carbon fiber is cathodically polarized at said voltage for a period of time of 2-4 hours.

10. The method of claim 1, wherein the amorphous carbon fiber is cathodically polarized at said voltage for a period of time of 1-3 hours.

11. The method of claim 1, wherein the amorphous carbon fiber is wrapped within and in contact with a metal mesh serving as a cathodic working electrode.

12. The method of claim 11, wherein the metal mesh is nickel mesh.

13. The method of claim 1, wherein the voltage is within a range of −2.4 V to −2.8 V.

14. The method of claim 1, wherein the voltage is about −2.6 V.

15. The method of claim 1, wherein said graphitized carbon fiber exhibits an x-ray diffraction peak at 2θ of 26°.

16. The method of claim 1, wherein the graphitized carbon fiber has a nanoflake architecture on its surface.

17. The method of claim 1, wherein the amorphous carbon fiber is a PAN-derived amorphous carbon fiber.

18. The method of claim 1, wherein the amorphous carbon fiber is a lignin-derived amorphous carbon fiber.

19. The method of claim 1, wherein the amorphous carbon fiber is a continuous carbon fiber of at least 1 meter in length, and the continuous carbon fiber is fed into and passed through the molten anhydrous alkaline earth salt in a continuous graphitization process.

20. The method of claim 19, wherein the continuous carbon fiber is held on a spool, unwound from the spool, and fed into and passed through the molten anhydrous alkaline earth salt in the continuous graphitization process.
